(19) United States
(12) Patent Application Publication
(10) Pub. No.: US 2022/0294539 A1
(43) Pub. Date: Sep. 15, 2022

(54) UNDERWATER OPTICAL COMMUNICATION DEVICE

(71) Applicant: Shimadzu Corporation, Kyoto (JP)

(72) Inventors: Kazutomo KADOKURA, Kyoto (JP); Mamoru HISAMITSU, Kyoto (JP); Kazuya INOUE, Kyoto (JP); Ryosuke NISHI, Kyoto (JP)

(21) Appl. No.: 17/132,728

(22) Filed: Mar. 12, 2021

(51) Int. Cl. H04B 10/80; H04B 13/02

(52) U.S. Cl. CPC H04B 10/80; H04B 13/02; G02B 6/4427

(57) ABSTRACT

An underwater optical communication device communicates with another underwater optical communication device. The underwater optical communication device is provided with an optical transmitter, an optical receiver, and a controller. The optical transmitter transmits laser light to another underwater optical communication device. The optical receiver receives laser light from another underwater optical communication device. The controller controls the optical transmitter and the optical receiver. The optical receiver is provided with a polarizing plate configured to transmit S-polarized light of natural light and suppress transmission of P-polarized light of natural light and a photodetector configured to detect laser light emitted from the polarizing plate.

### TECHNICAL FIELD

The present invention relates to an underwater optical communication device for performing optical communication underwater, and more particularly to an underwater optical communication device capable of improving an S/N ratio of communication.

### BACKGROUND

In underwater communication, communication using laser light is being realized instead of communication using a sound wave. Japanese Unexamined Patent Application Publication No. 2018-32918 describes an underwater communication device in which a receiving side underwater communication device analyzes the laser light received from a transmitting side underwater communication device to easily detect the position of the transmitting side communication device.

### SUMMARY

In optical communication, concealment, communication quantity, and communication rate are expected, but when receiving light, natural light entered in water is also detected as a light output together with laser light. Most of the S-polarized light components of natural light are reflected at the surface of the water, and mainly P-polarized light components propagate underwater.

Since natural light causing noise when receiving light is P-polarized light, the S/N ratio deteriorates in underwater communication.

It is an object of the present invention to provide an underwater optical communication device capable of improving an S/N ratio.

An underwater optical communication device according to the present invention performs communicating with another underwater optical communication device and includes an optical transmitter, an optical receiver, and a controller. The optical transmitter is configured to transmit laser light to the another underwater optical communication device. The optical receiver is configured to receive laser light from the another underwater optical communication device. The controller is configured to control the optical transmitter and the optical receiver. The optical receiver includes a polarizing plate configured to transmit S-polarized light of natural light and suppress transmission of P-polarized light of the natural light and a photodetector configured to detect laser light emitted from the polarizing plate.

The underwater optical communication device according to the present invention further includes a first rotation mechanism configured to rotate the polarizing plate. The controller rotates the polarizing plate by driving the first rotation mechanism based on a light output detected by the photodetector.

The controller rotates the polarizing plate by driving the first rotation mechanism so that a value of the light output detected by the photodetector falls within a range of ±10% of a light output minimum value.

The underwater optical communication device according to the present invention further includes a second rotation mechanism configured to rotate the optical transmitter. The controller rotates a polarization direction of outgoing light of the optical transmitter by driving the second rotation mechanism based on a light output detected by the photodetector.

The controller rotates the polarization direction of the outgoing light of the optical transmitter by driving the second rotation mechanism so that a value of the light output detected by the photodetector falls within a range of ±10% of a light output maximum value.

The underwater optical communication device according to the present invention further includes a third rotation mechanism configured to rotate a polarization-holding fiber. The optical transmitter includes the polarization-holding fiber. The controller rotates a polarization direction of outgoing light of the polarization-holding fiber by driving the third rotation mechanism based on a light output detected by the photodetector.

The controller rotates the polarization direction of the outgoing light of the polarization-holding fiber by driving the third rotation mechanism so that a value of the light output detected by the photodetector falls within a range of ±10% of a light output maximum value.

The underwater optical communication device according to the present invention further includes a second rotation mechanism configured to rotate the optical transmitter. The controller rotates a polarization direction of outgoing light of the optical transmitter by driving the second rotation mechanism based on a light output detected via the polarizing plate in the another underwater optical communication device.

The underwater optical communication device according to the present invention further includes a third rotation mechanism configured to rotate the optical transmitter. The optical transmitter includes a polarization-holding fiber. The controller rotates a polarization direction of outgoing light of the polarization-holding fiber by driving the third rotation mechanism based on a light output detected via the polarizing plate in the another underwater optical communication device.

According to the present invention, in the optical receiver, the polarizing plate transmits S-polarized light of natural light and suppresses the transmission of P-polarized light of the natural light, and the photodetector detects the laser light emitted from the polarizing plate. Therefore, the detected P-polarized light is greatly reduced, which in turn can improve the S/N ratio.

### BRIEF DESCRIPTION OF THE DRAWINGS

FIG. 1 is a configuration block diagram of an underwater optical communication device of Example 1.

FIG. 2 is a configuration block diagram of an underwater optical communication device of Example 2.

FIG. 3 is a configuration block diagram of an underwater optical communication device of Example 3.

FIG. 4 is a configuration block diagram of an underwater optical communication device of Example 4.

### DETAILED DESCRIPTION

Hereinafter, embodiments of the underwater optical communication device according to the present invention will be described in detail with reference to the attached drawings.

### (EXAMPLE 1)

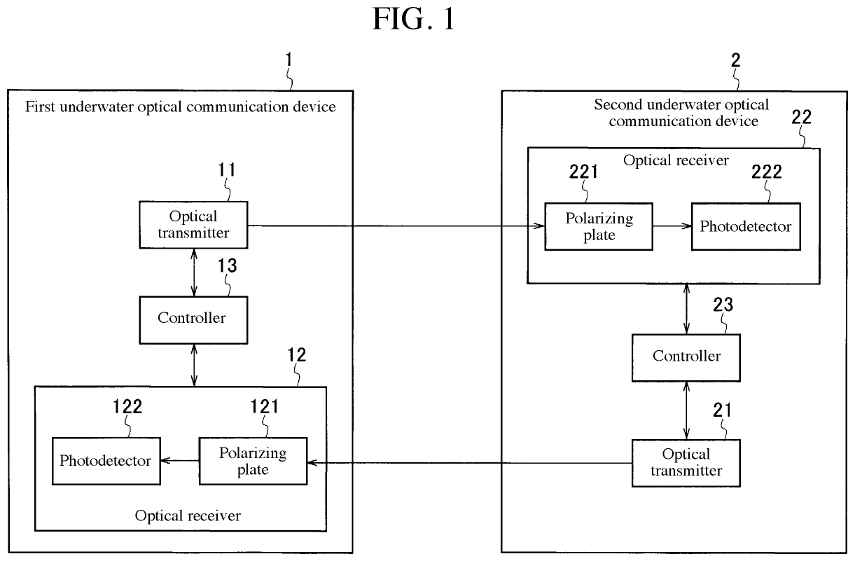

FIG. 1 is a configuration block diagram of an underwater optical communication device (a first underwater optical communication device 1 and a second underwater optical communication device 2) of Example 1. In Example 1, laser communication is performed between the first underwater optical communication device 1 and the second underwater optical communication device 2.

The first underwater optical communication device 1 includes an optical transmitter 11, an optical receiver 12, and a controller 13. The optical transmitter 11 couples the laser of a laser diode (not shown) to a fiber with a coupling lens and transmits the laser to the second underwater optical communication device 2.

The optical receiver 12 receives the laser from the second underwater optical communication device 2. The optical receiver 12 is provided with a polarizing plate 121 and a photodetector 122. The polarizing plate 121 transmits S-polarized light of natural light and suppresses transmission of P-polarized light of natural light. The photodetector 122 is composed of a photodiode (PD) or the like and detects the laser light emitted from the polarizing plate 121. The controller 13 controls the optical transmitter 11 and the optical receiver 12.

The second underwater optical communication device 2 is provided with an optical transmitter 21, an optical receiver 22, and a controller 23. The optical transmitter 21 couples the laser of the laser diode (not shown) to the fiber with a coupling lens and transmits the laser to the first underwater optical communication device 1.

The optical receiver 22 receives the laser from the first underwater optical communication device 1. The optical receiver 22 is provided with a polarizing plate 221 and a photodetector 222. The polarizing plate 221 transmits S-polarized light of natural light and suppresses the transmission of P-polarized light of natural light. The photodetector 222 is composed of a photodiode (PD) or the like and detects the laser light emitted from the polarizing plate 221. The controller 23 controls the optical transmitter 21 and the optical receiver 22.

As described above, according to the underwater optical communication device of Example 1, in the optical receiver 12, 22, the polarizing plate 121, 221 transmits S-polarized light of natural light and suppresses the transmission of P-polarized light of natural light, and the photodetector 122, 222 detects the laser light emitted from the polarizing plate 121, 221. With this configuration, P-polarized light to be detected is greatly reduced, so that the S/N ratio can be improved.

### (EXAMPLE 2)

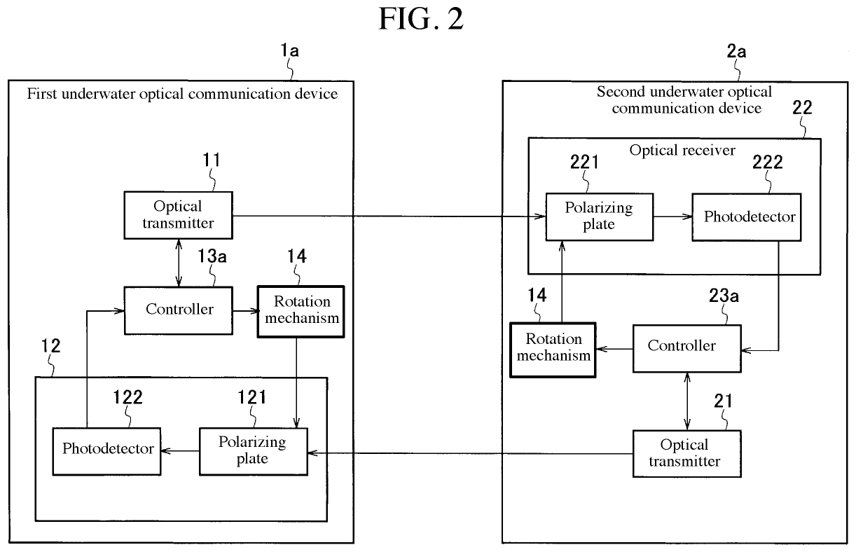

FIG. 2 is a configuration block diagram of an underwater optical communication device (a first underwater optical communication device 1a and a second underwater optical communication device 2a) of Example 2. In Example 2, in addition to the configuration of the underwater optical communication device of Example 1, the first underwater optical communication device 1a and the second underwater optical communication device 2a are each provided with a rotation mechanism (first rotation mechanism) 14, 14 for rotating the polarizing plate 121, 221.

Further, the controller 13a, 23a rotates the polarizing plate 121, 221 by driving the rotation mechanism 14, 14 based on the light output detected by the photodetector 122, 222.

In this case, the controller 13a, 23a rotates the polarizing plate 121, 221 by driving the rotation mechanism 14, 14 so that the value of the light output detected by the photodetector 122, 222 falls within a range of ±10% of the light output minimum value.

That is, the fact that the light output value detected by the photodetector 122, 222 falls within a range of ±10% of the light output minimum value indicates that the noise components due to the P-polarized light become small. By rotating the polarizing plate 121, 221, a condition small in the P-polarized light can be selected, which greatly improves the S/N ratio.

### (EXAMPLE 3)

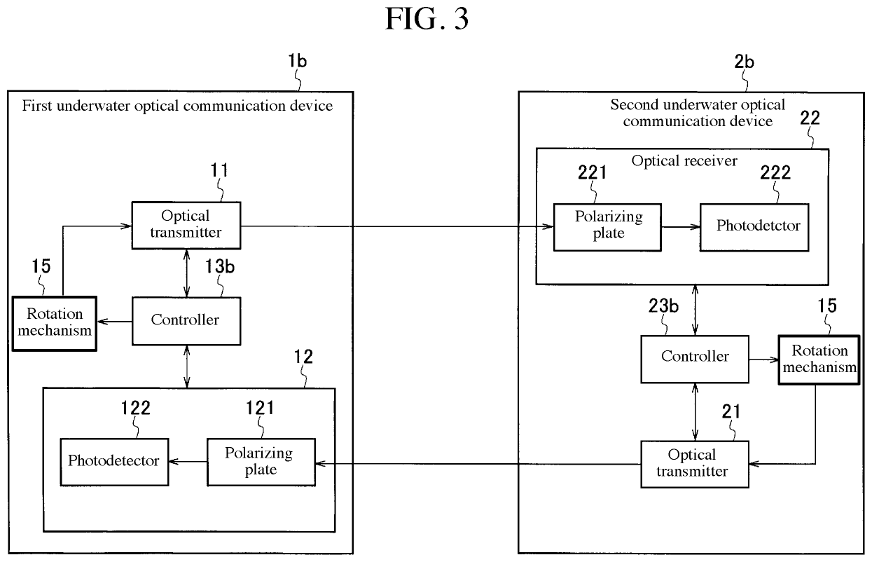

FIG. 3 is a configuration block diagram of an underwater optical communication device (a first underwater optical communication device 1b and a second underwater optical communication device 2b) of Example 3. In Example 3, in addition to the configuration of the underwater optical communication device of Example 1, the first underwater optical communication device 1b and the second underwater optical communication device 2b are each provided with a rotation mechanism (a second rotation mechanism) 15, 15 for rotating the optical transmitter 11, 21.

The controller 13b, 23b rotates the polarization direction of the outgoing light of the optical transmitter 11, 21 by driving the rotation mechanism 15, 15 based on the light output detected by the photodetector 122, 222.

In this case, the controller 13b, 23b rotates the polarization direction of the outgoing light of the optical transmitter 11, 21 by driving the rotation mechanism 15, 15 so that the value of the light output detected by the photodetector 122, 222 falls within a range of ±10% of the light output maximum value.

That is, the fact that the light output detected by the photodetector 122, 222 falls within a range of ±10% of the light output maximum value indicates that the communication efficiency can be approached maximization. Thus, by rotating the polarization direction of the outgoing light of the optical transmitter 11, 21, it is possible to maximize the communication efficiency.

### (EXAMPLE 4)

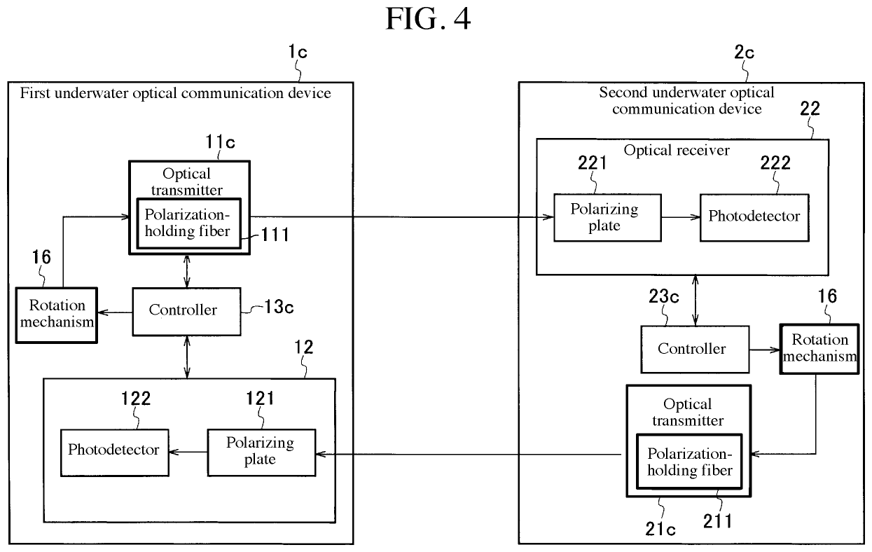

FIG. 4 is a configuration block diagram of an underwater optical communication device (a first underwater optical communication device 1c and a second underwater optical communication device 2c) of Example 4. In Example 4, in addition to the configuration of the underwater optical communication device of Example 1, the optical transmitter 11c of the first underwater optical communication device 1c and the optical transmitter 21c of the second underwater optical communication device 2c are each further provided with a polarization-holding fiber 111, 211.

Furthermore, the first underwater optical communication device 1c and the second underwater optical communication device 2c are each provided with a rotation mechanism (a third rotation mechanism) 16, 16 for rotating the polarization-holding fiber 111, 211.

The controller 13c, 23c rotates the polarization direction of the outgoing light of the polarization-holding fiber 111, 211 by driving the rotation mechanism 16, 16 based on the light output detected by the photodetector 122, 222.

In this case, the controller 13c, 23c rotates the polarization direction of the outgoing light of the polarization-holding fiber 111, 211 by driving the rotation mechanism 16, 16 so that the value of the light output detected by the photodetector 122, 222 falls within a range of ±10% of the light output maximum value.

That is, the fact that the light output detected by the photodetector 122, 222 falls within a range of ±10% of the light output maximum value indicates that the communication efficiency can be approached maximization. Thus, by rotating the polarization direction of the outgoing light of the optical transmitter 11c, 21c, it is possible to maximize the communication efficiency.

### (OTHER EXAMPLES)

As other Examples, the underwater optical communication device of Example 2 (FIG. 2) may be combined with the underwater optical communication device of Example 3 (FIG. 3) or the underwater optical communication device of Example 4 (FIG. 4).

For example, in the case of combining the underwater optical communication device (FIG. 2) of Example 2 and the underwater optical communication device (FIG. 3) of Example 3, in addition to the configuration of the underwater optical communication device configuration of Example 1, the first underwater optical communication device is further provided with the controller 13a, 13b, the rotation mechanism 14, and the rotation mechanism 15. Further, in addition to the configuration of underwater optical communication device of Example 1, the second underwater optical communication device is provided with the controller 23a, 23b, the rotation mechanism 14, and the rotation mechanism 15.

In this case, in the first underwater communication device, before the optical transmitter 21 emits the laser light, the controller 13a rotates the polarizing plate 121 (see FIG. 2) by driving the rotation mechanism 14 based on the light output detected by the photodetector 122.

For example, the controller 13a rotates the polarizing plate 121 by driving the rotation mechanism 14 so that the value of the light output detected by the photodetector 122 falls within a range of ±10% of the light output minimum value.

Similarly, in the second underwater communication device, before the optical transmitter 11 emits the laser light, the controller 23a rotates the polarizing plate 221 (see FIG. 2) by driving the rotation mechanism 14 based on the light output detected by the photodetector 222.

For example, the controller 23a rotates the polarizing plate 221 by driving the rotation mechanism 14 so that the value of the light output detected by the photodetector 222 falls within a range of ±10% of the light output minimum value.

Next, in the first underwater communication device, in order to match the polarization direction of the outgoing light of the optical transmitter 11 with the direction in which the controller 23a rotated the polarizing plate 221, the controller 13b rotates the polarization direction of the outgoing light of the optical transmitter 11 (see FIG. 2 and FIG. 3) by driving the rotation mechanism 15 based on the light output detected by the photodetector 222.

For example, after the optical transmitter 11 emits the laser light (outgoing light), the controller 13b acquires the value of the light output detected by the photodetector 222 from the second underwater optical communication device (e.g., the controller 23a or 23b) via a communication device (not shown). The controller 13b does not rotate the polarization direction of the outgoing light of the optical transmitter 11 when the value of the obtained light output is within a range of ±10% of the light output maximum value.

On the other hand, in case where the value of the obtained light output is not within a range of ±10% of the light output maximum value, the controller 13b rotates the polarization direction of the outgoing light of the optical transmitter 11 by driving the rotation mechanism 15. After the optical transmitter 11 emits the laser light (outgoing light), the controller 13b again acquire the value of the light output detected by the photodetector 222 from the second underwater optical communication device (e.g., controller 23a or 23b) via the communication device (not shown). The controller 13b continues this operation until the value of the acquired light output becomes within a range of ±10% of the light output maximum value. Thus, the communication efficiency can be maximized.

Note that in a case where the value of the light output detected by the photodetector 222 can be approximated by the value of the light output detected by the photodetector 122, in the same manner as in Example 3, the controller 13b may rotate the polarization direction of the outgoing light of the optical transmitter 11 by driving the rotation mechanism 15 so that the value of the light output detected by the photodetector 122 becomes within a range of ±10% of the light output maximum value.

Similarly, in the second underwater communication device, in order to match the polarization direction of the outgoing light of the optical transmitter 21 with the direction in which the controller 13a rotated the polarizing plate 121, the controller 23b rotates the polarization direction of the outgoing light of the optical transmitter 21 (see FIG. 2 and FIG. 3) by driving the rotation mechanism 15 based on the light output detected by the photodetector 122.

For example, after the optical transmitter 21 emits the laser light (outgoing light), the controller 23b acquires the value of the light output detected by the photodetector 122 from the first underwater optical communication device (e.g., controller 13a or 13b) via a communication device (not shown). In a case where the value of the obtained light output is within a range of ±10% of the light output maximum value, the controller 23b does not rotate the polarization direction of the outgoing light of the optical transmitter 21.

On the other hand, in a case where the value of the obtained light output is not within ±10% of the light output maximum value, the controller 23b rotates the polarization direction of the outgoing light of the optical transmitter 21 by driving the rotation mechanism 15. After the optical transmitter 21 emits the laser light (outgoing light), the controller 23b again acquires the value of the light output detected by the photodetector 122 from the first underwater optical communication device (e.g., controller 13a or 13b) via a communication device (not shown). The controller 23b continues this operation until the value of the acquired light output becomes within a range of ±10% of the light output maximum value. Thus, the communication efficiency can be maximized.

In case where the value of the light output detected by the photodetector 122 can be approximated by the value of the light output detected by the photodetector 222, in the same manner as in the Example 3, the controller 23b may rotate the polarization direction of the outgoing light of the optical transmitter 21 by driving the rotation mechanism 15 so that the value of the light output detected by the photodetector 222 becomes within a range of ±10% of the light output maximum value.

In a case where the incident angle of natural light incident on water varies with time, the controller 13a, 23a may rotate the polarizing plate 121, 221 at predetermined intervals by driving the rotation mechanism 14, 14 based on the light output detected by the photodetector 122, 222. In this case, the controller 13b, 23b also rotates the polarization direction of the outgoing light of the optical transmitter 11, 21 at predetermined intervals by driving the rotation mechanism 15, 15 based on the light output detected by the photodetector 222, 122. Thus, the controller 13b, 23b can match the polarization direction of the outgoing light of the optical transmitter 11, 21 with the direction in which the controller 23a, 13a rotated the polarizing plate 221,121.

In the case of combining the underwater optical communication device (FIG. 2) of Example 2 and the underwater optical communication device (FIG. 4) of Example 4, in addition to the configuration of the underwater optical communication device of Example 1, the first underwater optical communication device is further provided with a controller 13a, 13c, a rotation mechanism 14, a rotation mechanism 16, and a polarization-holding fiber 111. Further, in addition to the configuration of the underwater optical communication device of Example 1, the second underwater optical communication device is provided with a controller 23a, 23c, a rotation mechanism 14, a rotation mechanism 16, and a polarization-holding fiber 211. Also in this case, the same operation as the operation of the first underwater optical communication device and the second underwater optical communication device is performed in a case where the underwater optical communication device of Example 2 (FIG. 2) and the underwater optical communication device of Example 3 (FIG. 3) are combined.

The underwater optical communication device according to the present invention is applicable to a laser communication device.

1. A first underwater optical communication device for communicating with a second underwater optical communication device, comprising:
an optical transmitter configured to transmit laser light to the second underwater optical communication device;
an optical receiver configured to receive laser light from the second underwater optical communication device; and
a controller configured to control the optical transmitter and the optical receiver,
wherein the optical receiver includes a polarizing plate configured to transmit S-polarized light of natural light and suppress transmission of P-polarized light of the natural light and a photodetector configured to detect laser light emitted from the polarizing plate.

2. The first underwater optical communication device as recited in claim 1, further comprising:
a first rotation mechanism configured to rotate the polarizing plate,
wherein the controller rotates the polarizing plate by driving the first rotation mechanism based on a light output detected by the photodetector.

3. The first underwater optical communication device as recited in claim 2,
wherein the controller rotates the polarizing plate by driving the first rotation mechanism so that a value of the light output detected by the photodetector falls within a range of ±10% of a light output minimum value.

4. The first underwater optical communication device as recited in claim 1, further comprising:
a second rotation mechanism configured to rotate the optical transmitter,
wherein the controller rotates a polarization direction of outgoing light of the optical transmitter by driving the second rotation mechanism based on a light output detected by the photodetector.

5. The first underwater optical communication device as recited in claim 4,
wherein the controller rotates the polarization direction of the outgoing light of the optical transmitter by driving the second rotation mechanism so that a value of the light output detected by the photodetector falls within a range of ±10% of a light output maximum value.

6. The first underwater optical communication device as recited in claim 1, further comprising:
a third rotation mechanism configured to rotate a polarization-holding fiber,
wherein the optical transmitter includes the polarization-holding fiber, and
wherein the controller rotates a polarization direction of outgoing light of the polarization-holding fiber by driving the third rotation mechanism based on a light output detected by the photodetector.

7. The first underwater optical communication device as recited in claim 6,
wherein the controller rotates the polarization direction of the outgoing light of the polarization-holding fiber by driving the third rotation mechanism so that a value of the light output detected by the photodetector falls within a range of ±10% of a light output maximum value.

8. The first underwater optical communication device as recited in claim 1, further comprising:
a second rotation mechanism configured to rotate the optical transmitter,
wherein the controller rotates a polarization direction of outgoing light of the optical transmitter by driving the second rotation mechanism based on a light output detected via the polarizing plate in the second underwater optical communication device.

9. The first underwater optical communication device as recited in claim 1, further comprising:
a third rotation mechanism configured to rotate the optical transmitter,
wherein the optical transmitter includes a polarization-holding fiber, and
wherein the controller rotates a polarization direction of outgoing light of the polarization-holding fiber by driving the third rotation mechanism based on a light output detected via the polarizing plate in the second underwater optical communication device.
